(19) United States
(12) Patent Application Publication
(10) Pub. No.: US 2003/0185238 A1
(43) Pub. Date: Oct. 2, 2003

(54) System for maintaining original delivery times in transport packets and method thereof

(76) Inventors: David A. Strasser, North York (CA); Goran Cukljevic, Toronto (CA); Allen J.C. Porter, Sunderland (CA); Philip L. Swan, Richmond Hill (CA)

Correspondence Address: TOLER & LARSON & ABEL L.L.P., PO BOX 29567, AUSTIN, TX, 78755-9567, US

(21) Appl. No.: 10/112,897

(22) Filed: Apr. 1, 2002

(51) Int. Cl. H04J 3/24; H04J 3/06

(52) U.S. Cl. 370/473; 370/509

(57) ABSTRACT

A system and methods are provided for maintaining a timing relationship among data packets associated with a single program of a multiple program transport stream. Select data relating to a single multimedia program is selected from the multiple program transport stream. Timestamps, used to represent the time on a system time clock when particular packets are received, are attached to data packets from the single program. The time-stamped packets are stored in memory. When accessed back from memory, the timestamps are used to determine when to present the data of the packets. The data can then be used to construct a transport stream made up of only the data related to the selected single program.

### FIELD OF THE DISCLOSURE

The present invention relates generally to processing data streams and more particularly to maintaining timing relations among data packets of a data stream.

### BACKGROUND

Audio and visual components related to compressed MPEG-2 data must be properly synchronized for processing. The precise time to present uncompressed data is generally indeterminate relative to the time when the data is received in compressed form. Program clock references that are given during ‘stream time’ are transmitted in the adaptation field of audio or visual packets or auxiliary data at least ten times every second. A system may establish a reference of which time data should be given to an auxiliary decoder. A conventional system processes data from a data stream to synchronize to the program clock references. The system may then establish a presentation time for a particular data set according to the time the data set is received in reference to other received data sets. Using a stream time determined by the program clock references and the established presentation time, provided with the data set as a presentation time stamp (PTS), the data set is then passed to decoding components.

A clock local to the decoding system, a system time clock (STC), is used to provide the reference time to compare to the PTS values. The STC is a counter, or clock reference, maintained by the receiving (decoder) system. By comparing the values of the PTS to the system time clock and rendering the data associated with a particular PTS when a match occurs, a decoder may obtain synchronized presentation of audio and visual data. The STC must be properly synchronized to the clock of the encoding system to properly present the data. Program clock reference (PCR) values are occasionally provided within the transport stream. The STC can derive itself from the PCR values to synchronize to the encoding system.

Broadcasters must maintain specific timing relationships between packets of transmitted data to qualify particular broadcast video specifications, such as those related to the MPEG specification. A re-broadcaster attempting to broadcast video programs recorded from an original broadcast is burdened with maintaining the timing relationships according to the particular broadcast video specification. The re-broadcaster must maintain the timing associated with the original broadcast.

To playback the data related to a single program, the data from other programs must also be decoded to process the program clock reference information and establish a proper reference to when the data was received. A transport stream may include data related to multiple programs, or channels of multimedia information. The program clock references are spread among all the data in the multiple program transport stream. While some data packets associated with a single program include program clock references, presentation times for other data packets of the single program are determined from placements of the data packets in reference to other data packets that include the program clock references. If the data associated with the single program is stored without the data from other programs of the transport stream, the time relationship among the data packets received is lost and a presentation time may not be determined. To maintain the proper relation, the other data packets must also be processed.

When receiving data associated with multimedia programs, such as video and audio programs, the necessity to maintain data packet timing may become critical to the receiving system. Data packet timing is used in managing video and audio data buffers. The video and audio data buffers are used to store video and audio data prior to presentation. Analyses of the presentation times of the data packets are used to determine the sizes of the data buffers to be allocated. If the data packet timing is not maintained, the video and audio data buffers may overflow or underflow. If the video and audio data buffers overflow, multimedia data may be lost. If the video and audio data buffers underflow, the multimedia processing system may process all the data and become stalled waiting for new video or audio data. Accordingly, data packet timing must be maintained to allow for the management of video and audio data buffers.

The program clock references may also be altered to accommodate the data from the single program. Such methods create added processing overhead, which degrades the overall performance of the decoding system when attempting to store data packets from a single program or when attempting to play back stored packets associated with a single program. From the discussion above, it is apparent that an improved system for maintaining the timed relationship of transport packets related to a single program is needed.

### BRIEF DESCRIPTION OF THE DRAWINGS

Specific embodiments of the present invention are shown and described in the drawings presented herein. Various objects, advantages, features and characteristics of the present invention, as well as methods, operation and functions of related elements of structure, and the combination of parts and economies of manufacture, will become apparent upon consideration of the following description and claims with reference to the accompanying drawings, all of which form apart of this specification, and wherein:

FIG. 1 is a block diagram illustrating a system for storing a portion of a data stream, according to one embodiment of the present invention;

FIG. 2 is a block diagram illustrating data corresponding to processing performed using the system of FIG. 1, according to one embodiment of the present invention;

FIG. 3 is a block diagram illustrating a system for constructing a transport stream using stored transport stream data, according to one embodiment of the present invention;

FIG. 4 is a block diagram illustrating data corresponding to processing performed using the system of FIG. 3, according to one embodiment of the present invention;

FIG. 5 is a block diagram illustrating a transport packet parser for constructing a portion of a transport stream using stored time-stamped transport stream data, according to one embodiment of the present invention;

FIG. 6 is a flow diagram illustrating a method of storing transport packets pertaining to a portion of a transport stream, according to one embodiment of the present invention; and

FIG. 7 is a flow diagram illustrating a method of processing stored time-stamped transport packets to generate a transport stream, according to one embodiment of the present invention.

### DETAILED DESCRIPTION OF THE FIGURES

At least one embodiment of the present invention provides a method of storing packetized data including the element of parsing a multi-media data stream containing a plurality of data packets to identify a first subset of data packets having a first common identifier. The subset of data packets is related to a single program within the multi-media data stream. The method further includes determining, for a first individual packet of the first subset of data packets, a first time relative to a counter. The method includes storing a representation of the first time as a first timestamp. The timestamp is used to provide reference to the time at which a particular data packet was received, allowing the time between received packets to be recorded. The method further includes storing a representation of the first individual packet. The first timestamp is associated with the first individual packet. In one embodiment, the method includes determining a second timestamp for a second individual packet and storing representations of the second timestamp and the second individual packet. When the first and the second individual packets are retrieved from memory, the first and second individual timestamps may be used to provide reference for the time between the packets. An advantage of at least one embodiment of the present invention is that the relationship between data packets of a single program data stream may be maintained when stored and played back in a decoding system.

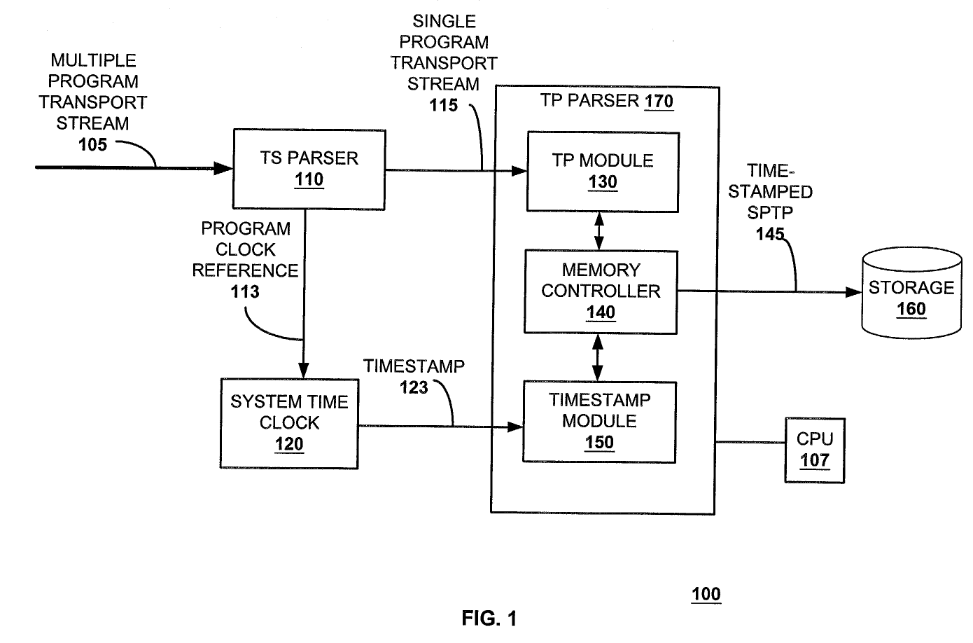

Referring now to FIG. 1, a block diagram illustrating a system for storing multimedia packets related to a single program data stream is shown and is generally referenced as receiving system 100, according to one embodiment of the present invention. Single program transport stream (SPTS) 115, from a multiple program transport stream 105, is processed into data packets and stored in memory, such as storage 160. A timestamp is provided for each of the data packets to maintain the timing between each received packet. SPTS 115 relates to a secondary transport stream representing portions of multiple program transport stream 105. In one embodiment, the portions relate to a single multimedia channel. It should be noted that the portions contained in SPTS 115 may include various PID values identifying video or audio channels related to the single multimedia channel. SPTS 115 may also include multiple multimedia channels representing a portion of a complete set of multimedia channels represented in multiple program transport stream 105.

Multiple program transport stream 105 is a multiplexed data stream that carries information regarding various programs of multimedia data. Data packets from multiple program transport stream 105 are organized serially. Occasionally, a program clock reference (PCR) 113 is provided for a single program of multiple program transport stream 105, to allow receiving system 100 to synchronize a local clock, such as system time clock (STC) 120, to a clock within a system (not shown) transmitting the multiple program transport stream. The PCR 113 is provided at predetermined intervals along the data packets associated with the single program of the multiple program transport stream 105. For example, in one embodiment, the PCR 113 is provided every 100ms. In one embodiment, the TS parser 110 reads the PCR 113 from the data packets associated with the single program and uses it to synchronize STC 120. In one embodiment, synchronization of STC 120 to PCR 113 is performed through the use of a phase-locked-loop (not shown). It should be noted that different PCR values, such as PCR 113, may be provided for each program provided through multiple program transport stream 105. For example, in one embodiment, PCR 113 is provided to reference timing for data packets within a single program associated with single program transport stream 115, taken from multiple program transport stream 105.

A transport stream parser 110 may be used to select only packets pertaining to a subset of data within the multiple program transport stream. In one embodiment, the subset of data pertains to a single program transport stream 115. In one embodiment, the transport stream parser 110 selects specific packets within multiple program transport stream 105 according to data fields embedded in the packets of multiple program transport stream 105. For example, only data with specific packet identifiers (PID) indicating relation to data packets associated with the SPTS 115 are passed along to transport packet (TP) module 130. It should be noted that a typical digital channel, such as SPTS 115 may include data packets of with various PID values, such as PIDs associated with multiple sets of audio data, video data, navigation and re-mapping data. Accordingly, several groups of different PID values may have to be considered to pass all the data packets associated with SPTS 115. Selection of the data streams and data packets to be taken from the multiple program transport stream may be made by a software application, through a data processor, such as central processing unit (CPU) 107, of system 100. CPU 107 may be used to assert options within TS parser 110, such as indicating the PIDs of the data packets to be selected. CPU 107 may also be used to apply settings to TP parser 170.

In one embodiment, the TP module 130 of TP parser 170, organizes the data from the SPTS 115 into single program transport packets. The timing for data packets which do not include PCR 113 values is generally referenced to the placement of the data packets in relation to the data packets with PCR 113 values, within multiple program transport stream 105. Since the original relationships of data packet placements in multiple program transport stream 105 is no longer be included with the transport packets of SPTS 115, the timing between completed transport packets must be actively maintained by system 100. The timing is used to determine the time at which the transport packets must be presented.

To maintain the timing between completed transport packets, a timestamp module 150 generates a timestamp for every transport packet of SPTS 115 completed. In one embodiment, when TP module 130 has received a complete transport packet, timestamp module 150 generates a timestamp 123 based on a representation of the current time provided through STC 120. Since STC 120 is synchronized using PCR 113, the timestamp 123 may provide a reference to the time data of a particular transport packet was received. In one embodiment, the timestamp 123 is taken from a representation of the value of STC 120 with the two most-significant bytes stripped off. In one embodiment, a 4-byte header is attached to the data related to the particular transport packet, including 2-bytes of timing information from STC 120 and two bytes which may be reserved for storing any pertinent data associated with the data packets.

A memory controller 140 may be used to store transport packets from SPTS 115 and related timestamps 123 in memory, such as storage 160. In one embodiment, every transport packet related to SPTS 115 is provided a separate timestamp 123. Memory controller 140 combines the transport packets with their respective timestamps 123 to generate time-stamped single program transport packets (SPTP) 145. In one embodiment, the SPTPs are of a predetermined size of 188 bytes and the addition of the time stamp provides an additional 4-bytes to the total byte-length of the data packets. The time-stamped SPTPs 145 are then 192-bytes long. The time-stamped SPTP 145 provides the data related to the single program transport stream 115 while maintaining the timing relationship between received transport packets. Accordingly, the timing relationship can be recreated when the time-stamped SPTPs 145 are accessed from storage 160 at a later time. The SPTPs and the time-stamped SPTPs 145 may also be represented through other sizes. The sizes of the SPTPs and the time-stamped SPTPs 145 may be altered without departing from the scope of the present invention.

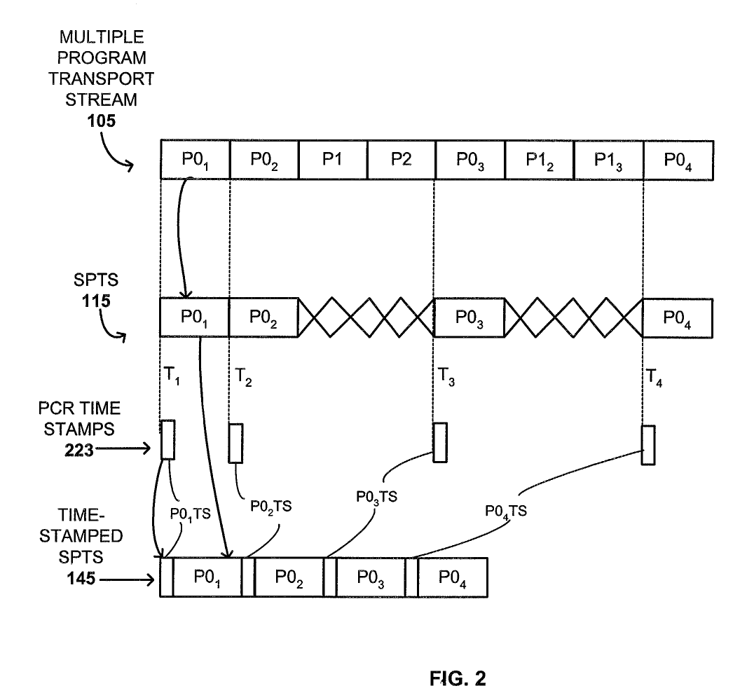

Referring now to FIG. 2, data corresponding to system 100 (FIG. 1) is shown, according to one embodiment of the present invention. Timestamps 223 are generated for individual transport packets related to a single program. The timestamps are provided with the individual transport packets to generate time-stamped SPTPs 145, which provide a reference for the relative placement of the individual transport packets within the original multiple program transport stream 105.

As shown in FIG. 2, a portion of multiple program transport stream 105, includes data packets related to various programs P0-P2. While data is provided for packets P1 and P2, only data related to program P0 is desired, in the illustrated embodiment. Data related to only program P0 may be extracted from multiple program transport stream 105 through a transport stream parser, such as TS parser 110 (FIG. 1). The data related to program P0 represents a subset of the total data provided through the multiple program transport stream 105. P0 may represent data from a particular program within the multiple program transport stream. P0 may include a subset of data identified through a common identifier, such as a common PID found among data fields within P0 data.

The data related to program P0, P0₁-P0₄, may be organized as a single program transport stream 115. Individual packets related to program P0 do not contain timing information, such as times T₁-T₄, related to their original placement and timing relationship within multiple program transport stream 105. If the individual packets are stored and played back, the timing information is needed to play back the individual packets at an appropriate and synchronized time.

To maintain the timing relationship related to the placement and timing relationship of the data packets from the single program transport stream 115, timestamps 223 are generated. In one embodiment, each timestamp of timestamps 223 is used to indicate when receiving hardware has received a complete, particular packet of single program transport stream 115. For example, timestamp P0₁TS is generated using a representation of time T₁, at which SPTP P0₁ is received. Timestamp P0₂TS is generated from time T₂, at which SPTP P0₂ is received. Timestamps P0₃TS and P0₄TS are respectively generated for SPTPs P0₃ and P0₄, using T₃ and T₄. The timestamps 223 may then be used to determine the timing delay between each of the SPTPs P0₁-P0₄. Timestamps 223 may be used to identify the start of the particular packets of SPTS, indicating the time when the first bit of the particular packet is received. Alternatively, timestamps 223 may identify the end of the packet, indicating the time when the last bit of the packet was received. The particular portion of the particular packet, in relation to multiple program transport stream 105, to which a timestamp of timestamps 223 indicates may be altered and, so long as timestamps 223 consistently indicate the same portion of respective transport packets, the portion represented may be altered without departing from the scope of the present invention.

The timestamps 223 are combined with respective SPTP values to generate time-stamped SPTPs 145. In one embodiment, the SPTPs are stored in memory. When the SPTPs are read back from memory, the timestamps may be used to appropriately reconstruct the SPTP 115, providing the appropriate delays between individual packets.

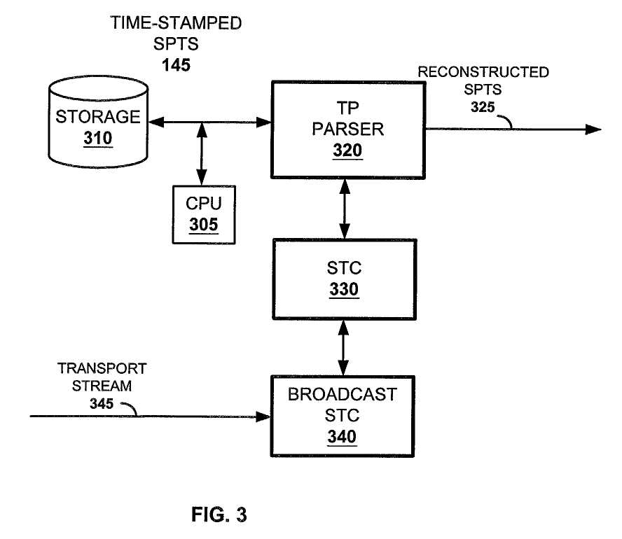

Referring now to FIG. 3, a block diagram illustrating a system for presenting stored SPTPs for playback is shown, according to one embodiment of the present invention. Stored transport packets are accessed from storage 310. Timestamps in a time-stamped SPTP 145 are used to determine an appropriate time to present the SPTP. The SPTP may then be processed for playback.

In one embodiment, a transport packet (TP) parser 320 is used to read the time-stamped SPTPs 145 from memory, such as storage 310. For every time-stamped SPTP 145, the timestamp is stripped from the corresponding SPTP. The timestamp is compared to a representation of the STC to determine when to parse the data of the time-stamped SPTP 145. In one embodiment, the least significant 2-bytes of STC 330 are compared to the timestamp. The parsed data may be used to generate a reconstructed single program transport stream 325. The reconstructed single program transport stream 325 may be used to match the placement of data of a single program transport stream within the original multiple program transport stream 105 (FIG. 1).

It should be noted that STC 330 should be properly synchronized. In one embodiment, STC 330 is synchronized to a second STC, referenced to as a broadcast STC. In one embodiment, the broadcast STC is referenced through a broadcast transport stream, such as transport stream 345, associated with a transport stream transmitting system (not shown). As previously discussed in reference to FIG. 1, the transmitting system places PCR values within data fields of a transport stream 345. A broadcast STC module may be used to maintain the current value of the PCR from transport stream 345 for synchronizing STC 330.

A live transport stream may then be used to maintain proper synchronization of STC 330, through broadcast STC module 340. In one embodiment, video playback is time-shifted from a live broadcast feed. Video and audio data corresponding to a current, single program are being received; however, the video and audio data are to be played back after a delay, such as a thirty minute delay. Accordingly, the program is being played back in a time-shifted manner. If the program is still currently being received, a reference can still be made to the value of the broadcast STC 340, updated through PCR values in transport stream 345. The value of STC 330 is locked to the value of the transmitting systems clock, through broadcast STC 340. An offset may be provided as a delay to the value of STC 330, allowing the SPTP 145 associated with the first timestamp to be presented by TP parser 320 at a later time. Alternatively, the STC 330 may be set to match a representation of the broadcast STC 340.

In one embodiment, a separate clock, internal to the system of FIG. 3 and more accurate than STC 330, may be used in place of broadcast STC module 340 to maintain proper timing synchronization for STC 330. The playback system may no longer be receiving a live transport stream 345 associated with the stored time-stamped SPTS 145. To maintain a synchronized clock, STC 330 may be initialized with a PCR value from time-stamped SPTS 145 and maintained through reference to a fixed local clock. For example, as most broadcast systems use a 27 MHz clock rate to provide multimedia data, a local 27 MHz clock may be used to synchronize STC 330. It should be noted that dependent on the fixed clock used, the values of STC 330 may drift or deviate from the original timing values used in broadcast. However, slight deviations in clock value may not be noticeable to a user.

In on embodiment, a phase locked loop is used to maintain synchronization to the broadcast STC 340. It should be appreciated that other methods of synchronizing STC 330 to a referenced clock, such as broadcast STC 340 or a fixed clock, may be used. For example, the referenced clock values may be filtered and compared to STC 330 to maintain synchronization. Adjustments to the filtering may be used to maintain multiplied or divided clock values synchronized to the referenced clock.

Time-stamped single program transport packets associated with a different program than time-stamped single program transport packets 145 may also be stored in storage 310. All the data packets may be parsed using the system described and may be included in the output transport stream, such as reconstructed single program transport stream. In one embodiment, software applications are used to assert settings of TP parser 320, through a data processor, such as CPU 305. The settings may include determining which time-stamped transport stream packets to access from storage 310.

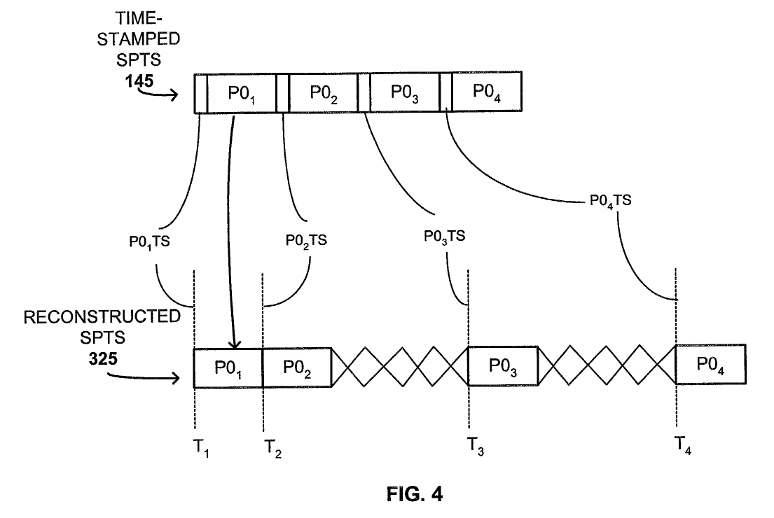

Referring now to FIG. 4, data corresponding to processing performed using the system described in reference to FIG. 3 is shown, according to one embodiment of the present invention. Using timestamps provided through the time-stamped SPTPs 145, a single program transport stream 325 may be reconstructed with transport packets presented at appropriate times.

As described in reference to FIG. 1, SPTPs are time-stamped to provide appropriate timing relationships between the deliveries of the SPTPs within a single program transport stream. The timestamps, P0₁TS-P0₄TS, are used to determine the appropriate placements of respective SPTPs P0₁-P0₄ within reconstructed SPTS 325. For example, a first timestamp P0₁TS may identify a time T₁ at which to place P0₁ on reconstructed SPTS 325. A second SPTP P0₂TS maybe placed on SPTS 325 at time T₂, according to timestamp P0₂TS. Accordingly, P0₃TS is used to place SPTP P0₃ on single program transport stream 325 at time T₃, and P0₄TS is used to place SPTP P0₄ on SPTS at time T₄. The reconstructed single program transport stream 325 may be used in place of the original multiple program transport stream 105 (FIG. 1), using only the data related to program P0.

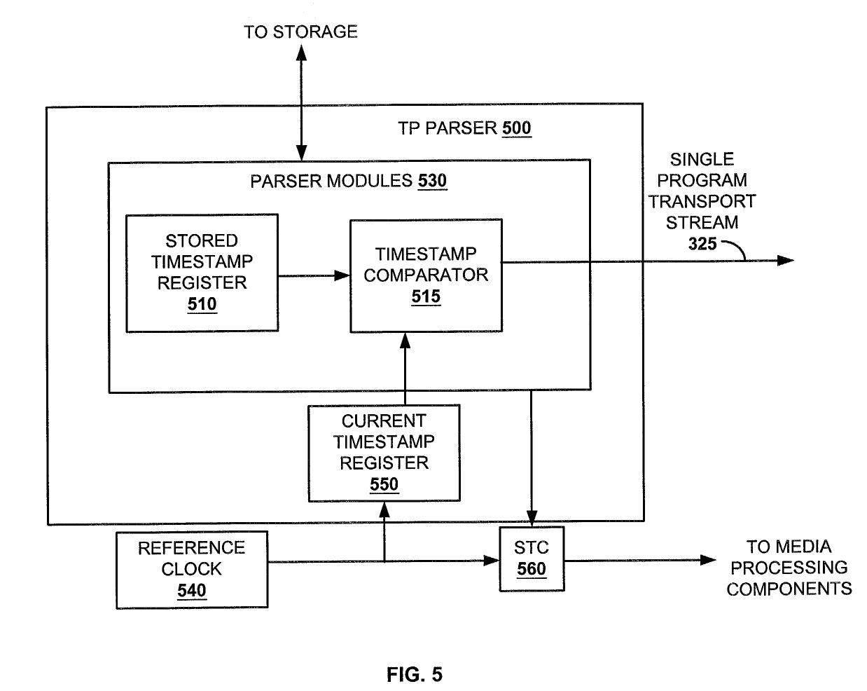

Referring now to FIG. 5, a block diagram illustrating functional components of a TP parser 500 is shown, according to one embodiment of the present invention. Time-stamped SPTPs are access from memory storage (not shown). STC 560 is initialized using a first PCR value received from the stored time-stamped SPTPs. A value of the STC 560 is maintained through synchronization with a reference clock 540. The STC 560 may also be synchronized through a live broadcast transport stream, such as broadcast STC module 340 (FIG. 3). Synchronization of STC 560 is used to provide proper timing for playback of the time-stamped SPTP stored in memory. STC 560 is provided to media processing components for processing data from SPTS 325.

Time-stamped SPTPs are not played until the timestamps match a representation of the STC 560. In one embodiment, a timestamp associated with an SPTP is read through parser modules 530 and stored in stored timestamp register 510. The timestamp value of stored timestamp register 510 is compared against a representation of the STC, such as STC 560. In one embodiment, the least significant 2-bytes of the value of STC 560 is stored as a current timestamp value in current timestamp register 550. A comparator 515 checks the value in stored timestamp register 510 against the value in stored timestamp register 550. If the values are equivalent, parser modules 530 pass the value of the associated SPTP from memory to an output single program transport stream 325. If the value of stored timestamp register 510 is different from the value of current timestamp register 550, the comparator 515 waits until the value of current timestamp register 550, updated through STC 560, reaches the timestamp value of stored timestamp register 510.

In one embodiment, a reference clock 540 is used to synchronize STC 560. A broadcast STC module may be maintained using a live broadcast transport stream to maintain synchronization to a clock in the encoding system. Reference clock 540 may be locked to match a value of a broadcast clock for synchronizing STC 560. Alternatively, a fixed, accurate clock may be maintained by TP parser 500 to provide synchronization exclusively for time-stamped SPTPs. Reference clock 510 may include a fixed 27 MHz clock for maintaining a synchronization of STC 560.

Parser modules 530 may be used to selectively parse packets regarding specific data. For example, parser modules 530 may be provided to only pass packets that include specific field values or PIDs. The parser modules 530 provide the single program transport packets as a continuous single program transport stream 375. The single program transport stream may then be re-broadcast or processed through a multimedia decoding system.

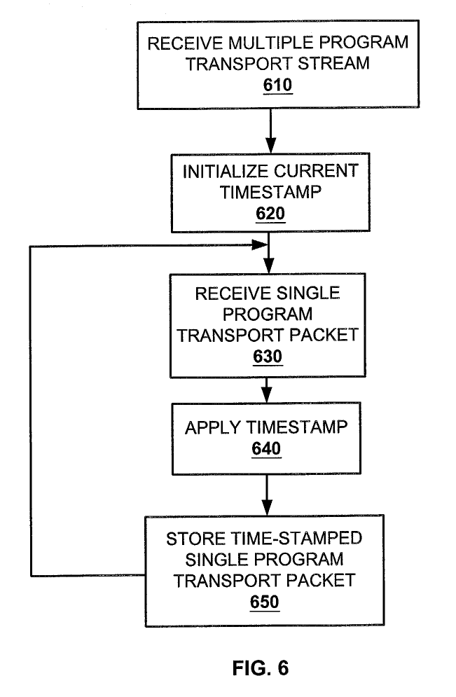

Referring now to FIG. 6, a flow diagram illustrating steps for generating time-stamped single program transport streams are shown, according to one embodiment of the present invention. When selecting single program transport packets for storage, the timing relationship between the received packets is generally lost. To maintain the relationship between single program transform packets, timestamps are stored with the single program transport packets.

In step 610, a multiple program transport stream is received through a transport stream parser. The multiple program transport stream includes multimedia data related to multiple multimedia programs, or channels. In step 620, a program clock reference is extracted from data within the multiple program transport stream. The program clock reference is associated with a particular program and is used to initialize a timestamp value. The timestamp value is used to track the times that data packets associated with the program are received. In one embodiment, the program clock reference is included within a field of the data sent in the multiple program transport stream, every 100 ms. The timestamp value may be applied to new data packets that are received, tracking a time each one is received.

In step 630, a first single program transport packet associated with a first single program is parsed from the multiple program transport stream. In one embodiment, if the a program clock reference is included with the transport packet, the program clock reference is used to synchronize and STC, allowing the STC to maintain a valid time for incrementing and tracking timestamps while receiving a live broadcast transport stream. Alternatively, a local, fixed clock may be used to synchronize the STC. In step 640, a first timestamp is applied to the first single program transport packet. The first timestamp provides the time in the receiving system, according to the STC, at which the first single program transport packet was received.

In one embodiment the first timestamp represents the value of the STC with the most significant 2-bytes stripped from the final value. In one embodiment the first timestamp is applied as a 4-byte header to the first transport packet, using 2-bytes of timing information and 2-bytes reserved for extraneous information, such as forward error correction and/or indexing information. In step 650, the first single program transport packet is stored in memory with the first timestamp attached to it. The process may return to step 630 to continue receiving more single program transport packets from the multiple program transport stream. In one embodiment, single program transport streams from programs other than the first program are also received and stored in memory. So long as the proper timing information related to the transport packets is retained through the use of the timestamps, the single program transport streams may be reconstructed when accessed from memory.

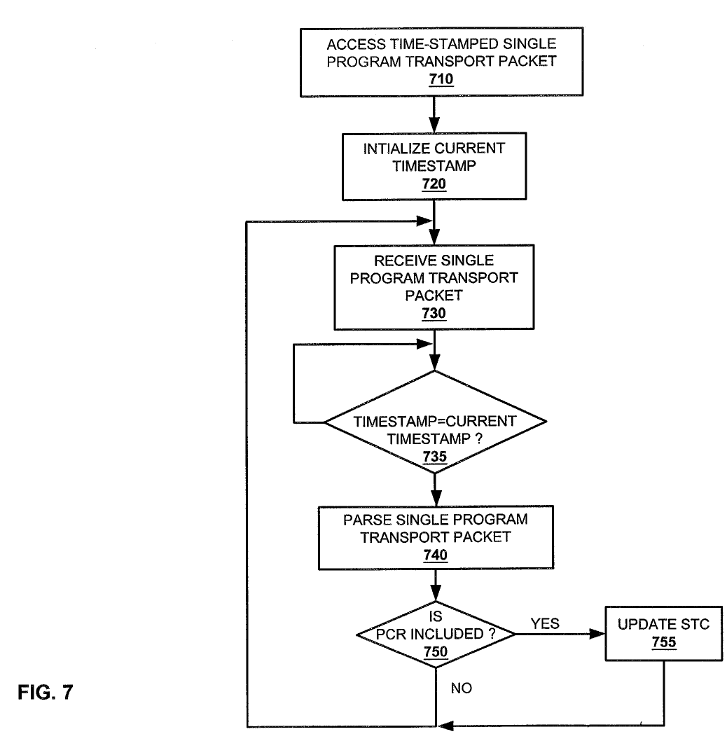

Referring now to FIG. 7, a flow diagram illustrating steps for reconstructing a single program transport stream from memory is shown, according to one embodiment of the present invention. Stored single program transport streams containing timestamps are accessed from memory and used to construct a single program transport stream.

In step 710, a first time-stamped single program transport packet is accessed from memory to identify a first timestamp value. A timestamp included in the time-stamped single program transport packet may be used to determine when to present the packet within the constructed single program transport stream. In step 720 a value tracking a current timestamp to be passed is initialized to the timestamp of the time-stamped transport packet. The value of the current timestamp may be incremented using an STC to determine when to pass particular time-stamped transport packets.

In step 730, a time-stamped program transport packet is passed to a transport packet parser to determine if it should be passed. In step 735, the value of the timestamp included with the time-stamped single program transform packet is compared to a representation of the current timestamp being tracked. If the value of the timestamp of the transport packet is not equivalent with the current timestamp being tracked, the system waits until the timestamp matches the current timestamp, which is updated using the STC. In step 740, if the values are equivalent, the single program transport packet is separated from the time-stamped single program transport packet and parsed. The data from the parsed single program transport packet may be sent as part of a transport stream.

In step 750, it is determined if a program clock reference is included with the data of the parsed transport packet. In step 755, if a PCR is identified, the STC may be updated to match the program clock reference, allowing the STC to be synchronized with a transmitting system, if a live broadcast is being received from the transmitting system.

If further packets from the single program transport packet are desired, the system may return to step 730, where a new time-stamped single program transport packet may be accessed from memory. It should be noted that other time-stamped single program transport packets associated with other single programs may also be accessed from memory and parsed into the transport stream.

The systems described herein may be part of an information handling system. The term “information handling system” refers to any system that is capable of processing information or transferring information from one source to another. An information handling system may be a single device, such as a computer, a personal digital assistant (PDA), a hand held computing device, a cable set-top box, a personal video recorder (PVR), an Internet capable device, such as a cellular phone, and the like. Alternatively, an information handling system may refer to a collection of such devices. It should be appreciated that while components of the system have been describes in reference to multimedia processing components, the present invention may be practiced using other types of system components. It should be appreciated that the system described herein has the advantage of obtaining and maintaining synchronization. While a specific method of processing platform independent commands has been described herein, it should be appreciated that other methods may be employed without departing from the scope of the present invention.

In the preceding detailed description of the embodiments, reference has been made to the accompanying drawings which form a part thereof, and in which is shown by way of illustration specific embodiments in which the invention may be practiced. These embodiments are described in sufficient detail to enable those skilled in the art to practice the invention, and it is to be understood that other embodiments may be utilized and that logical, mechanical, chemical and electrical changes may be made without departing from the spirit or scope of the invention. To avoid detail not necessary to enable those skilled in the art to practice the invention, the description may omit certain information known to those skilled in the art. Furthermore, many other varied embodiments that incorporate the teachings of the invention may be easily constructed by those skilled in the art. Accordingly, the present invention is not intended to be limited to the specific form set forth herein, but on the contrary, it is intended to cover such alternatives, modifications, and equivalents, as can be reasonably included within the spirit and scope of the invention. The preceding detailed description is, therefore, not to be taken in a limiting sense, and the scope of the present invention is defined only by the appended claims.

What is claimed is:

1. A method of storing packetized data comprising the steps of:
parsing a multi-media stream containing a plurality of data packets to identify a first subset of data packets having a common identifier;
determining, for a first individual packet of the first subset of data packets, a first time based on a counter;
storing a representation of the first time; and
storing a representation of the first individual packet of the first subset of data packets,
wherein the first is associated with the first individual packet of the first subset of data packets.

2. The method as in claim 1, wherein the multi-media data stream includes an MPEG type transport stream.

3. The method as in claim 1, wherein each of the plurality of data packets are of a first predetermined size.

4. The method as in claim 3, wherein the first predetermined size is 188 bytes.

5. The method as in claim 3, wherein the stored representation of the first time and the stored representation of the first individual packet are combined to form a time-stamped packet.

6. The method as in claim 5, wherein the time-stamped packet is of a second predetermined size.

7. The method as in claim 5, wherein the second predetermined size is fixed.

8. The method as in claim 7, wherein the second predetermined size is 192 bytes.

9. The method as in claim 5, wherein the second predetermined size is variable.

10. The method as in claim 9, wherein the representation of the first time is fixed.

11. The method as in claim 10, wherein the representation of the first individual packet is of variable length.

12. The method as in claim 1, wherein the common identifier includes a packet identifier.

13. The method as in claim 1, further including determining a time relative to the counter for each of the individual packets of the first subset of data.

14. The method as in claim 1, wherein the counter includes a system time clock.

15. The method as in claim 1, wherein all of the plurality of data packets have the common identifier.

16. The method as in claim 1, wherein the representation of the first time and the representation of the first individual packet are stored in memory.

17. The method as in claim 16, wherein the memory is accessed linearly.

18. The method as in claim 1, further including the steps of:
determining for a second individual packet of the first subset of data packets a second time based on the counter;
storing a representation of the second time as a second time; and
storing a representation of the second individual packet of the first subset of data packets,
wherein the second time is associated with the second individual packet of the first subset of data packets.

19. The method as in claim 18, wherein the multi-media data stream includes an MPEG type transport stream.

20. The method as in claim 18, wherein the common identifier includes a packet identifier.

21. The method as in claim 18, wherein the counter includes a system time clock.

22. The method as in claim 18, wherein the representation of the first time and the representation of the first individual packet are stored in memory.

23. The method as in claim 22, wherein the memory is accessed linearly.

24. The method as in claim 1, further including the steps of:
parsing the multi-media stream containing the plurality of data packets to identify a second subset of data packets having a common identifier;
determining, for a first individual packet of the second subset of data packets, a second time based on the counter, wherein the second time is after the first time;
storing a representation of the second time as a second time; and
storing a representation of the first individual packet of the second subset of data packets,
wherein the second time is associated with the first individual packet of the second subset of data packets.

25. The method as in claim 24, further including the steps of:
determining for a second individual packet of the first subset of data packets a third time relative to the counter;
storing a representation of the third time as a third time; and
storing a representation of the second individual packet of the first subset of data packets,
wherein the third time is associated with the second individual packet of the first subset of data packets.

26. A method of parsing stored packetized data including the steps of:
accessing a first data associated with a first data packet stored in memory, wherein the first data packet is associated with a first subset of data packets;
initializing a first counter based on a first program clock reference, wherein the first program clock reference is part of the first data;
reading a first portion of the first data to determine a first presentation time of a second portion of the first data;
monitoring the first counter to determine if a representation of the first counter matches the first presentation time; and
providing the second portion of the first data dependent on a match between the first counter and the first presentation time.

27. The method as in claim 26, wherein memory is linearly accessed.

28. The method as in claim 26, wherein the first counter is a system time clock.

29. The method as in claim 26, wherein the step of initializing the first counter includes delaying the first counter by an offset value.

30. The method as in claim 26, wherein the first portion of the first data includes a timestamp associated with the first data packet.

31. The method as in claim 26, wherein the first program clock reference is derived from the timestamp associated with the first data.

32. The method as in claim 26, further including the steps of:
accessing a second data associated with a second data packet stored in memory, wherein the second data packet is associated with the first subset of data packets;
reading a first portion of the second data packet to determine a second presentation time of a second portion of the second data;
monitoring the first counter to determine if a representation of the first counter matches the second presentation time; and
providing the second portion of the second data dependent on a match between the first counter and the second presentation time.

33. The method as in claim 32, wherein the first counter is a system time clock.

34. The method as in claim 32, wherein the first portion of the second data includes a timestamp associated with the second data.

35. The method as in claim 34, wherein the first portion of the first data includes a timestamp associated with the first data.

36. The method as in claim 32, wherein the first program clock reference is derived from the timestamp associated with the first data packet.

37. The method as in claim 26 further including the steps of:
accessing a second data associated with a second data packet stored in memory, wherein the second data packet is associated with a second subset of data packets;
initializing a second counter based on a second program clock reference, wherein the second program clock reference is part of the second data;
reading a first portion of the second data to determine a second presentation time of a second portion of the second data;
monitoring the second counter to determine if a representation of the second counter matches the second presentation time; and
providing the second data portion of the second data dependent on a match between the second counter and the second presentation time.

38. The method as in claim 37, wherein the first portion of the first data packet includes a first timestamp and the first portion of the second data packet includes a second timestamp.

39. The method as in claim 38, wherein the first program clock reference is derived from the first timestamp and the second program clock reference is derived from the second timestamp.

40. A system comprising:
a data processor having an I/O buffer;
a memory having an I/O buffer coupled to the I/O buffer of the data processor;
a transport stream parser capable parsing a multi-media stream containing a plurality of data packets to identify a first subset of data packets having a common identifier;
a timestamp module capable of determining, for a first individual packet of the first subset of data packets, a first time based on a counter;
a memory control module capable of:
storing a representation of the first time in memory; and
storing a representation of the first individual packet of the first subset of data packets in memory, wherein the first time is associated with the first individual packet of the first subset of data packets; and
a counter capable of providing a time reference.

41. The system as in claim 40, wherein the counter is a system time clock.

42. The system as in claim 41, wherein the timestamp module is further capable of determining, for a second individual packet of the first subset of data packets, a second time based on the counter and further wherein the memory control module is further capable of storing a representation of the second time in memory and storing a representation of the second individual packet, wherein the second time is associated with the second individual packet.

43. A system comprising:
a data processor having an I/O buffer;
a memory having an I/O buffer coupled to the I/O buffer of the data processor;
a memory controller capable of:
accessing a first data associated with a first data packet stored in memory,
wherein the first data packet is associated with a first subset of data packets;
a timestamp register capable of storing a first time value based on a first portion of the first data;
a timestamp comparator capable of monitoring the first counter to determine if a representation of the counter matches the first time value;
a transport packet parser capable of providing a second portion of the first data dependent on a match between the first counter and the first time value; and
a first counter capable of providing a time reference.

44. The system as in claim 43, wherein a program clock reference is derived from the first time.

45. The system as in claim 43, wherein:
the memory controller is further capable of accessing a second data associated with a second data packet stored in memory, wherein the second data packet is associated with the first subset of data packets;
the timestamp register is further capable of storing a second time value based on a first portion of the second data;
the timestamp comparator is further capable of monitoring the first counter to determine if a representation of the counter matches the second time value; and
the transport packet parser is further capable of providing a second portion of the second data dependent on a match between the first counter and the second time.
